(19) United States
(12) Patent Application Publication
(10) Pub. No.: US 2008/0305680 A1
(43) Pub. Date: Dec. 11, 2008

(54) Electrical connector assembly

(75) Inventors: Terrance F. Little, York, PA (US); Kevin E. Walker, Hershey, PA (US); Stephen Sedio, Vallery Center, CA (US)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD

(21) Appl. No.: 12/157,058

(22) Filed: Jun. 6, 2008

Related U.S. Application Data
(63) Continuation-in-part of application No. 11/810,711, filed on Jun. 7, 2007.

(51) Int. Cl. H01R 13/66; H01R 24/00

(52) U.S. Cl. 439/541.5; 439/676

(57) ABSTRACT

A connector assembly includes a main substrate (20) disposed in a substantially vertical orientation within a connector housing (10). Four conductor-holding halves (301, 303, 401, 403), laterally and longitudinally aligned with each other, are mounted onto opposite front and rear faces of the main substrate for forming a complete upper connector, and a complete lower connector. This arrangement of the upper and lower ports shares a common main substrate, and is optimal from space usage due to having full advantage of opposed face areas defined by the main substrate.

### CROSS-REFERENCE TO RELATED APPLICATIONS

This application is a Continuation-in-part Application of U.S. patent application Ser. No. 11/810,711, filed Jun. 7, 2007, and entitled “ELECTRICAL CONNECTOR ASSEMBLY”, which has the same applicant and assignee as the present invention.

### BACKGROUND OF THE INVENTION

1. Field of the Invention

The present invention relates to the art of electrical connectors, and more particularly to a single- or multi-port connector assembly which may include internal electronic components.

2. Description of Related Art

Existing modular jack/connector technology commonly utilizes individual discrete components such as choke coils, filters, resistors, capacitors, transformers, and LEDs disposed within the connector to provide the desired functionality. The use of the discrete components causes considerable difficulty in arranging a layout within the connector, especially when considering electrical performance criteria also required by the device. Often, one or more miniature printed circuit boards (PCBs) are used to arrange the components and provide electrical interconnection therebetween. Such PCBs consume a significant amount of space in the connector. Design efforts have been made trying to dispose the one or more PCBs in the connector housing in various way while not compromising electrical performance. At least in the case of disposing multiple PCBs, however, the manufacturing cost of the connector will increase.

U.S. Pat. No. 6,872,098 issued to Wojtacki et al. on Mar. 29, 2005 discloses such a connector assembly. The connector assembly includes two PCBs mounted orthogonally relative to a conductor-holding member. The conductor-holding member, belonging to a stacked connector, respectively interconnects the two PCBs, which have signal conditioning components thereon. Most of the signal conditioning components are disposed on opposite internal faces of the at least two PCBs. In the interior volume of the connector, the ratio of usable volume to total volume within the connector is not optimized.

U.S. Pat. No. 6,773,302 issued to Gutierrez et al. on Aug. 10, 2004 exemplifies a multi-port connector assembly having a plurality of PCBs disposed in a vertical orientation with respect to a front face of the connector housing. In this configuration, a row of conductors usable in a single connector shares a single PCB, which also has the signal conditioning components thereon. This arrangement, however, is also not optimal in space usage in that each row of the upper and lower conductors within the respective connectors is merely disposed on one of the opposite internal faces of two adjacent PCBs.

Therefore, there is a need to provide a connector assembly to resolve the above-mentioned problem.

### BRIEF SUMMARY OF THE INVENTION

Accordingly, it is an object of the present invention to provide an electrical interconnection system which allows for individual cards to disconnect from each other without disengaging entire row or column of connectors.

A connector assembly according to an embodiment of the present invention includes a connector housing, a main substrate, and upper left and upper right conductor-holding halves and lower left and lower right conductor-holding halves. The main substrate is disposed in a substantially vertical orientation within, and substantially orthogonal to a front face of the housing. The main substrate includes an edge section having a front face, a rear face and a side face extending transverse to the front and rear faces, with the side face adapted to face the connector housing. The main substrate also includes at least one electrically conductive pathway adjacent to the edge section. The upper left and upper right conductor-holding halves and the lower left and lower right conductor-holding halves, laterally and longitudinally aligned with each other, are mounted onto the opposite front and rear faces and adapted to form a complete upper conductor-holding member of an upper connector, and a complete lower conductor-holding member of a lower connector, respectively. An upper row of conductors are disposed within the upper left and upper right conductor-holding halves, and a lower row of conductors disposed within the lower left and lower right conductor-holding halves, the upper and lower rows of conductors being in electrical connection with the at least one electrically conductive pathway of the main substrate. This arrangement of the upper and lower ports shares a common main substrate, and is optimal from space usage due to having full advantage of opposed face areas defined by the main substrate.

Other objects, advantages and novel features of the invention will become more apparent from the following detailed description of the present embodiment when taken in conjunction with the accompanying drawings.

### BRIEF DESCRIPTION OF THE DRAWINGS

The foregoing summary, as well as the following- detailed description of the preferred embodiments of the present invention, will be better understood when read in conjunction with the appended drawings. For the purpose of illustrating the invention, there is shown in the drawings, embodiments which are presently preferred. It should be understood, however, that the present invention is not limited to the precise arrangements and instrumentality shown in the attached drawings.

FIG. 1 is an exploded, perspective view of a connector assembly including a main substrate and upper and lower conductor-holding halves according to an embodiment of the present invention;

FIG. 2 is a perspective view of the main substrate of FIG. 1;

FIG. 3 is a perspective view of the upper conductor-holding halves of FIG. 1 during an over-molding process;

FIG. 4 is a perspective view of the upper conductor-holding halves of FIG. 1 after an over-molding process;

FIG. 5 is another exploded, perspective view of the upper conductor-holding halves of FIG. 4;

FIG. 6 is an assembled, perspective view of the upper and lower conductor-holding halves of FIG. 1;

FIG. 7 is a perspective view showing the upper and lower conductor-holding halves of FIG. 6 for solder tail connection to the main substrate;

FIG. 8 is a side view of the sub-assembly of FIG. 7;

FIG. 9 is an exploded, perspective view showing the sub-assembly of FIG. 7 and a bottom card-edge connector, through which the connector assembly of FIG. 1 is electrically mounted to a mother board;

FIG. 10 is an assembled, perspective view of the sub-assembly of FIG. 9;

FIG. 11 is a cross-sectional view showing the sub-assembly of FIG. 10 mounted within a main connector housing;

FIG. 12 is an assembled, perspective view of upper and lower conductor-holding halves according to a second embodiment of the present invention;

FIG. 13 is a perspective view showing the upper and lower conductor-holding halves of FIG. 12 for surface mount connection to the main substrate;

FIG. 14 is a perspective view showing upper and lower conductor-holding halves for press-fit connection to the main substrate;

FIG. 15 is an exploded, perspective view showing the sub-assembly of substrates according to a second embodiment of the present invention, the sub-assembly of substrates including the main substrate of FIG. 1 and small substrates;

FIG. 16 is an assembled, perspective view of the sub-assembly of substrates of FIG. 15;

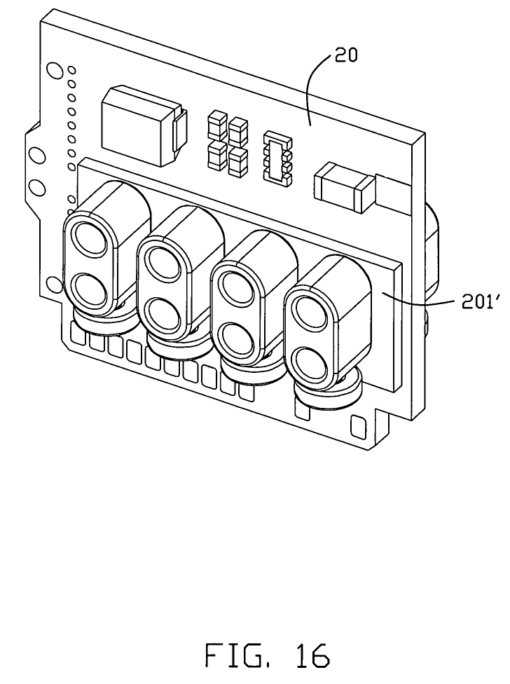

FIG. 17 is an exploded, perspective view showing the sub-assembly of substrates according to a third embodiment of the present invention, the sub-assembly of substrates including two entirely separate substrates;

FIG. 18 is a perspective view showing the sub-assembly of substrates of FIG. 17 and the bottom card-edge connector of shown in FIG. 9;

FIG. 19 is an exploded, perspective view of the bottom card-edge connector in accordance with an embodiment;

FIG. 20 is an exploded, perspective view of the bottom card-edge connector in accordance with another embodiment;

FIG. 21 is a perspective view of the bottom card-edge connector in accordance with still another embodiment;

FIG. 22 is an exploded, perspective view of the bottom card-edge connector shown in FIG. 21;

FIG. 23 is a view similar to FIG. 22 while from a different aspect;

FIG. 24 is a perspective view showing the bottom card-edge connector co-work with a pair of LED; and

FIG. 25 is a perspective view showing the bottom card-edge connector co-work with a pair of light-pipes.

### DETAILED DESCRIPTION OF THE PREFERRED EMBODIMENT

Reference will now be made to the drawing figures to describe the present invention in detail.

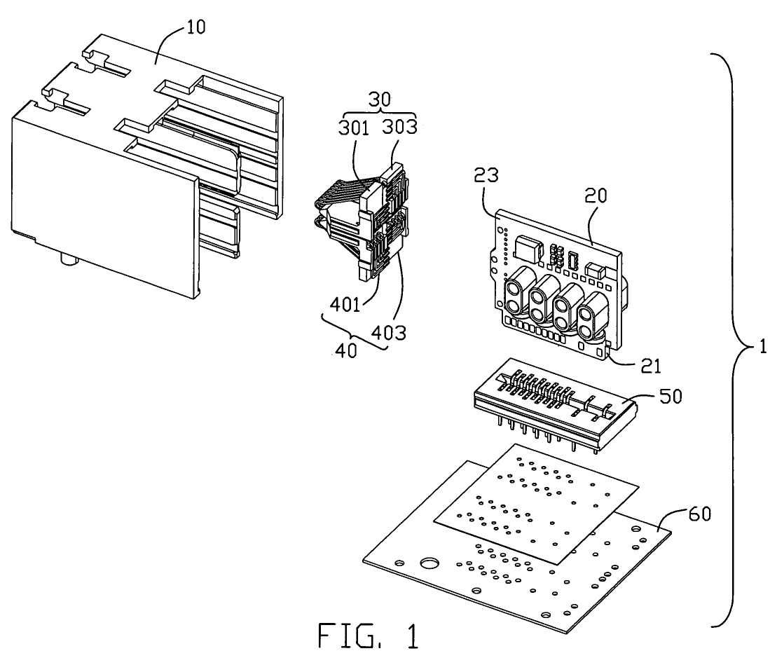

Referring to FIG. 1, a connector assembly 1 according to an embodiment of the present invention includes a connector housing 10, a main substrate 20 disposed in a substantially vertical orientation within and orthogonal to a front face of the connector housing 10, upper left and upper right conductor-holding halves 30, and lower left and lower right conductor-holding halves 40, detachably mounted upon the main substrate 20 respectively (to be later described).

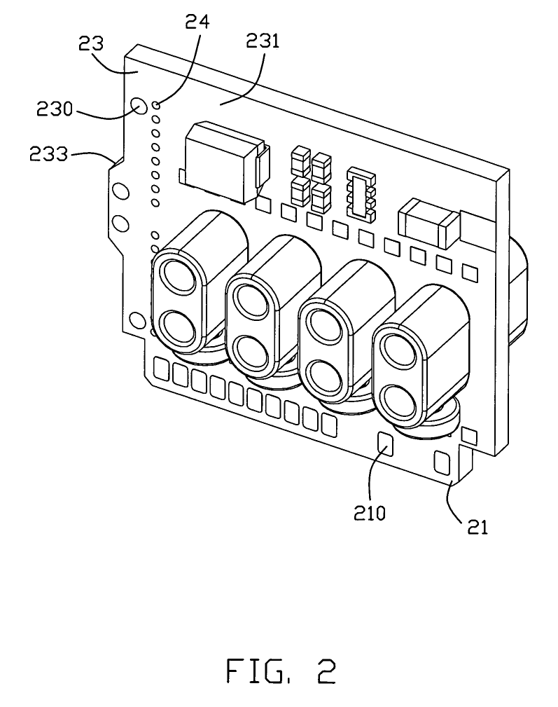

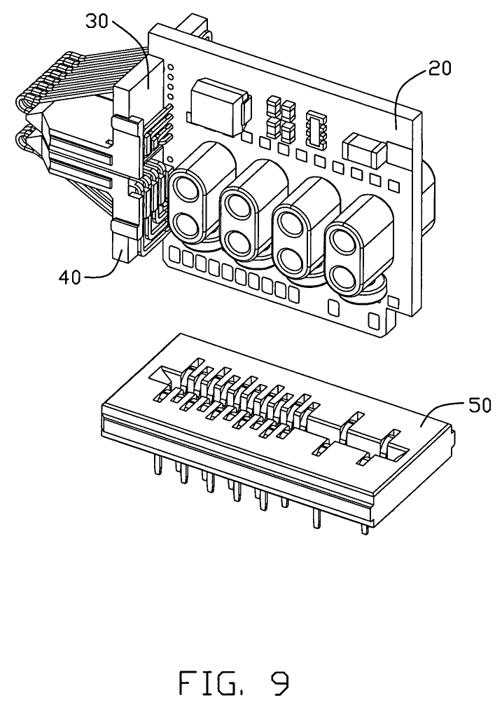

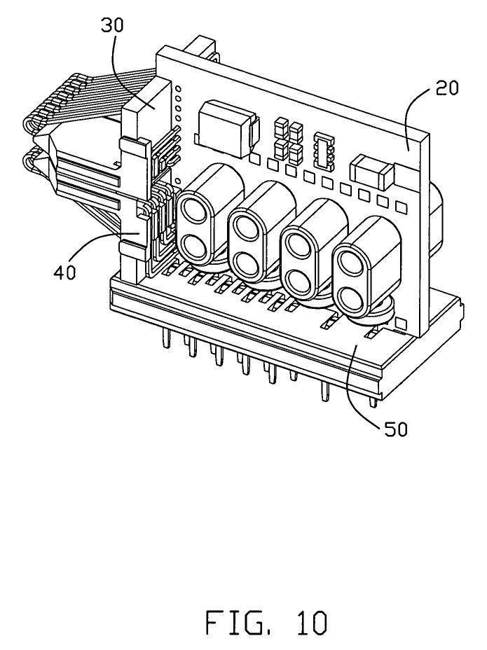

The main substrate 20 defines a lengthwise edge section 21 and a transverse edge section 23 transverse to the lengthwise edge section 21, and includes signal conditioning components mounted on opposite faces around a central region adjacent to the lengthwise and transverse edge sections 21 and 23. The lengthwise edge section 21 is provided with edge contact pads 210 (in FIG. 2), through which the main substrate 20 is electrically connected to a bottom card-edge connector 50 and then to a mother-board 60 (see FIGS. 1, 9 and 10). The transverse edge section 23 has a front face 231, an opposite rear face, and a side face 233 extending transverse to the front and rear faces (see FIG. 2). The side face 233 is adapted to face towards the connector housing 10. The transverse edge section 23 of the main substrate 20 is provided with apertures 230 for inter-engaging elements 311, 313, 411 and 413 (to be later described) to be extended therethrough.

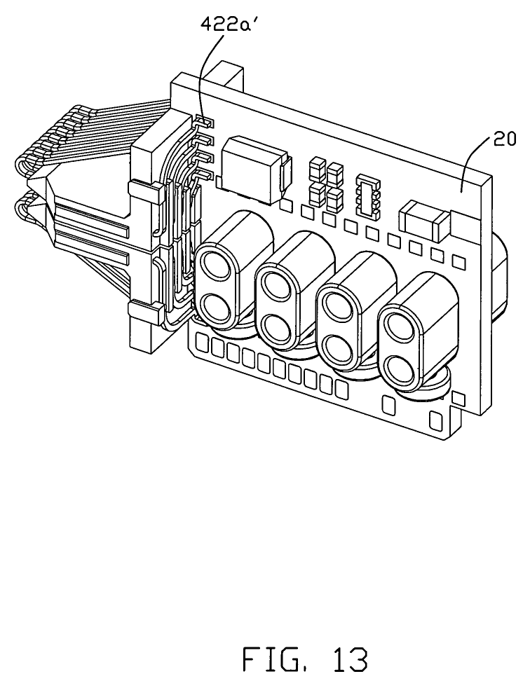

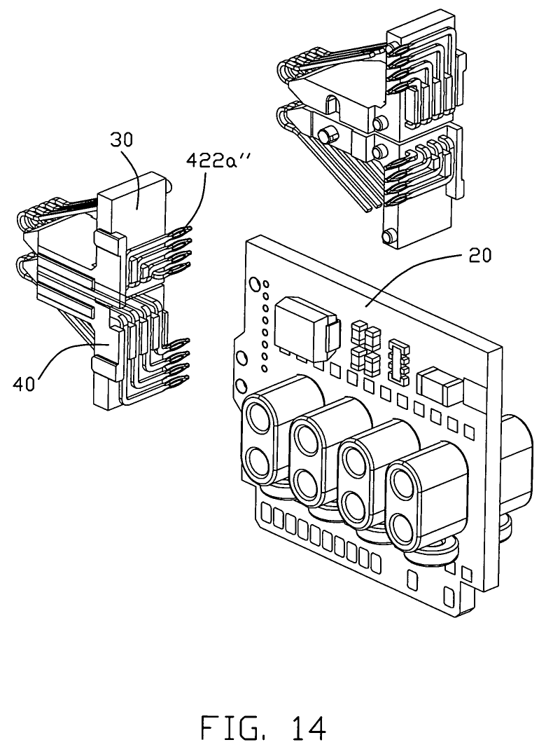

The main substrate 20 is provided with at least one electrically conductive pathway 24 adjacent to the transverse edge section 23. In this embodiment shown in FIG. 2, the at least one electrical conductive pathway 24 is in form of a plurality of metal-plated through holes, which electrically connect with signal conditioning components through the internal circuitry formed across the main substrate 20. Conductors 321, 323, 421 and 423 within the conductor-holding halves are to be solder tail connection to the main substrate 20 through the use of the through holes, thereby resulting in an electrical connection between the conductors 321, 323, 421 and 423, and the at least one electrical conductive pathway 24 of the main substrate 20. However, in an alternative embodiment shown in FIG. 13, the at least one electrical conductive pathway 24 is in form of a plurality of area contact pads (not labeled), through which conductors 321′, 323′, 421′ and 423′ within the conductor-holding halves are to be surface mount connection to the main substrate 20. Besides soldering and/or surface mounting, press-fit connection shown in FIG. 14 is also contemplated. That is, the conductors within the conductor-holding halves 30 and 40 include first conductor segments 422a″ for press-fit connection to said main substrate 20.

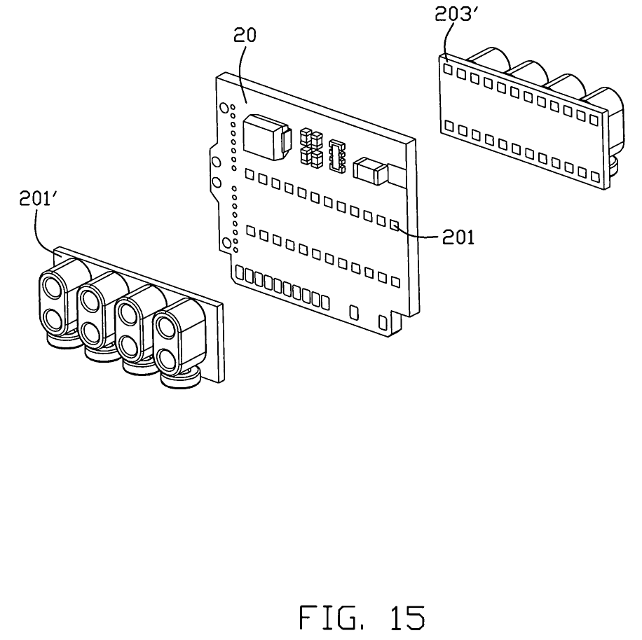

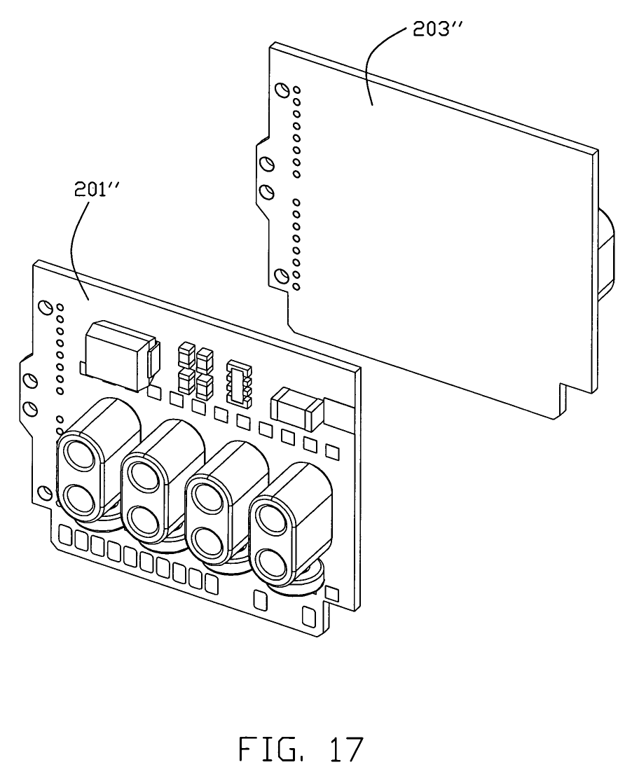

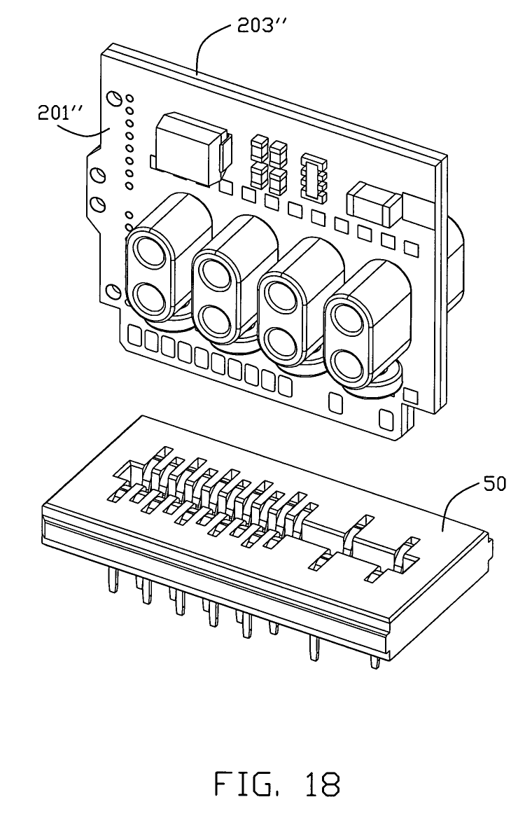

In this embodiment of FIG. 2, the signal conditioning components are divided into two general groups, including such as resistors and capacitors etc. Each group is disposed on one of the opposite faces around the central region of the main substrate 20, with one group for the upper connector and another group for the lower connector. However, in other alternative embodiments, all the signal conditioning components on the opposite faces of the main substrate 20 may be simultaneously shared by the upper and lower ports, without need of being namely divided into two general groups. This arrangement of the signal conditioning components will take full advantage of opposite face areas of the main substrate 20, thereby having an optimal space usage within the connector housing 10. Further, another option for mounting the signal conditioning components is to utilize additional small substrates 201′ and 203′ separable from the main substrate 20 (see FIGS. 14 and 15). The main substrate 20 includes small substrate area contact pads 201 for the additional small substrates 201′ and 203′ to be re-flow soldered to the main substrate 20, forming an electrical connection between the main substrate 20 and the signal conditioning components through the small substrates 201′ and 203′. The advantage of utilizing these small additional substrates 201′ and 203′ would be for ease of solderability, whereas the signal conditioning components, such as magnetic torroids, may be soldered separately as a unit. Besides the above option of using the main substrate 20 and the small substrates 201′ and 203′, the option of using two entirely separate substrates 201″ and 203″, as shown in FIGS. 17 and 18, is also contemplated, with every one substrate having the signal conditioning components thereon for each of the upper and lower ports. The two entirely separate substrates 201″ and 203″ are mounted in a back-to-back manner to be inserted into a board-receiving channel formed along a lengthwise direction of the card-edge connector 50.

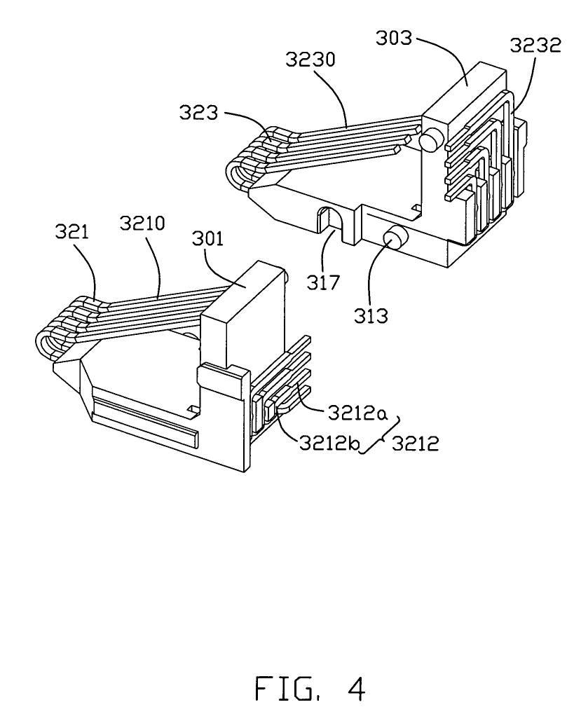

Referring to FIGS. 4 to 6, each of the conductor-holding halves 301, 303, 401 or 403 includes half of a row of conductors over-molded therein. That is, the upper left conductor-holding half 301 has half of an upper row of conductors 321 disposed therein, and the upper right conductor-holding half 303 has half of an upper row of conductors 323, thereby forming a complete conductor-holding member for an upper connector, while the lower left conductor-holding half 401 has half of a lower row of conductors 421 disposed therein, and the lower right conductor-holding half 403 has half of a lower row of conductors 423, thereby forming a complete conductor-holding member for a lower connector.

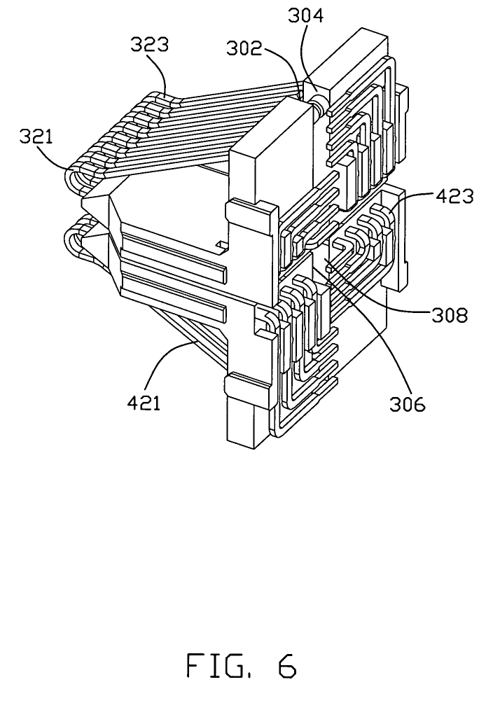

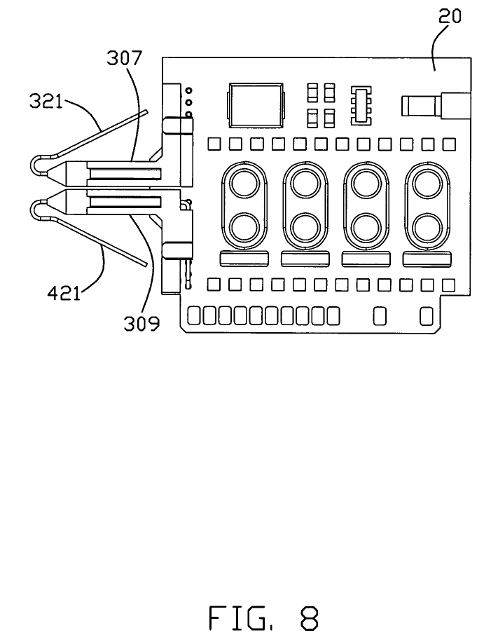

The upper left and upper right conductor-holding halves 301 and 303 define upper front ends, upper rear ends, upper surfaces 307 (see in FIG. 8), and upper interior side edges 302 and 304 (see in FIG. 6) opposite to each other, while the lower left and lower right conductor-holding halves 401 and 403 define lower front ends, lower rear ends, lower surfaces 309 (see in FIG. 8), and lower interior side edges 306 and 308 (see in FIG. 6) opposite to each other. In FIG. 4, the upper row of conductors 321 and 323 on the upper left and upper right conductor-holding halves are configured to extend from the upper front ends towards the upper rear ends. The upper row of conductors 321 and 323, juxtaposed in a row, includes upper jack contact portions 3210 and 3230 extending adjacent to the upper surfaces 307 for mating with a mating plug, and upper printed circuit board contact portions 3212 and 3232 extending adjacent to the opposite upper interior side edges 302 and 304 for electrically engaging with the main substrate 20. In this embodiment, the upper jack contact portions 3210 and 3230 are configured to extend upwardly from the upper surfaces 307, while the upper printed circuit board contact portions 3212 and 3232 are to extend towards the opposite upper interior sides 302 and 304. Similarly, in FIG. 6, the lower row of conductors is configured to extend from the lower front ends towards the lower rear ends. In this embodiment, the lower row of conductors 421, juxtaposed in a row, includes lower jack contact portions extending downwardly from the lower surfaces 309, and lower printed circuit board contact portions extending towards the opposite lower interior sides 306 and 308. In each conductor-holding half, a plane defined by each jack contact portion 3210 or 3230 extends orthogonally relative to a plane defined by each corresponding printed circuit board contact portion 3212 or 3232. Further, as shown in FIG. 8, portions of the conductors 321, 323, 421 and 423 being held by the respective conductor-holding halves extends parallel to the front or rear face of the main substrate 20.

In this embodiment, the respective printed circuit board contact portions 3212 or 3232 (for simplifying the illustration, merely the upper row of conductor labeled) of each conductor-holding half are substantially coplanar and separated from one another. The printed circuit board contact portions 3212 and 3232 within the four conductor-holding halves are arranged such that those of the upper right conductor-holding half 303 are held symmetrical with respect to those of the lower left conductor-holding half 401 relative to a central point defined by the four conductor-holding halves, and those of the upper left conductor-holding half 301 have a symmetry with respect to those of the lower right conductor-holding half 403.

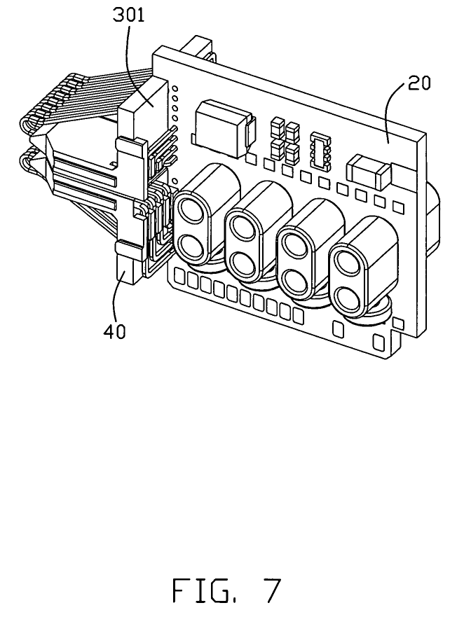

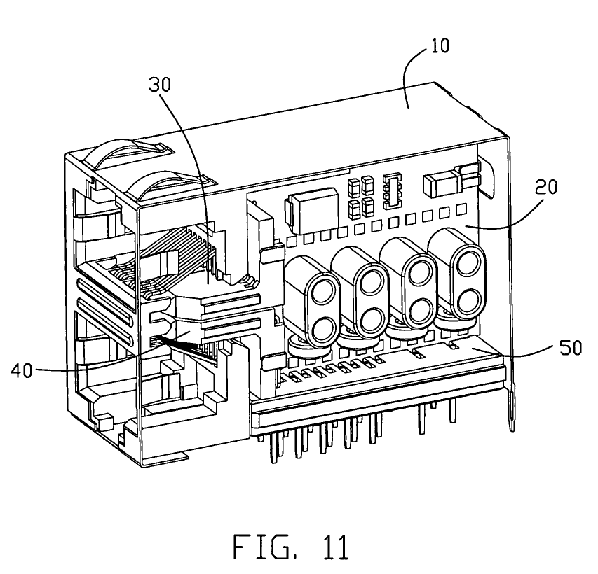

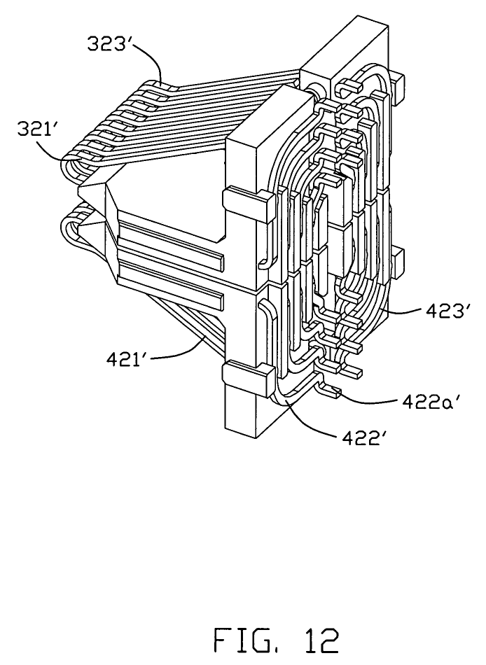

In the first embodiment of FIGS. 1 and 3-11, each of the respective printed circuit board contact portions 3212 includes at least two conductor segments including a first conductor segment 3212a and a second conductor segment 3212b extending at approximately 90 degree from the first conductor segment 3212b. The first conductor segment 3212a is oriented substantially normal to the main substrate 20 for the purpose of solder tail connection to the main substrate 20 through the metal-plated through holes. In the second embodiment of FIGS. 12 and 13, each printed circuit board contact portion 422′ (for simplifying the illustration, merely one printed circuit board contact portion labeled) includes three conductor segments having a first conductor segment 422a′, a second conductor segment and a third conductor segment, by forming an angle of 90 degree between every two adjacent segments. The first conductor segment 422a′ extends substantially parallel to the front face of the main substrate 20 for surface mount connection to the main substrate 20 through the formation of edge contact pads (not labeled) on the main substrate 20.

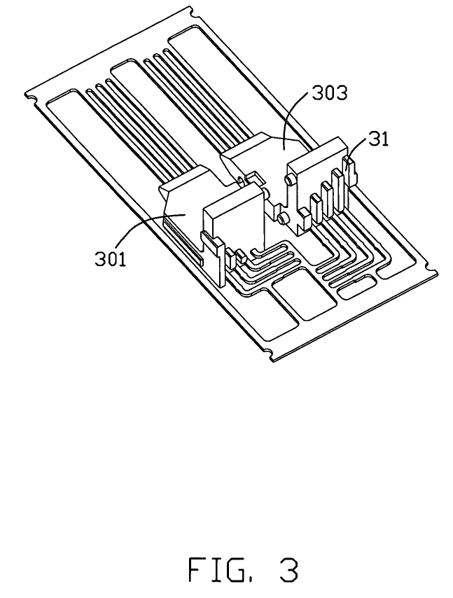

In the above embodiments, each of the conductor-holding halves includes a plurality of grooves 31 (labeled in FIG. 3), by forming a row of ribs thereon, for frictionally receiving at least a portion of the respective printed circuit board contact portions so as to hold the respective conductors 321, 323, 421 and 423 in position. In FIG. 6, the upper left and upper right conductor-holding halves 301 and 303 and the lower left and lower right conductor-holding halves 401 and 403, laterally and longitudinally aligned with each other, are detachably mounted upon the opposite front and rear faces of the main substrate in order to form a complete conductor-holding member for an upper connector, and a complete conductor-holding member for a lower connector. This arrangement will take full advantage of opposed face areas defined by the main substrate 20, thereby having an optimal space usage within the connector housing 10.

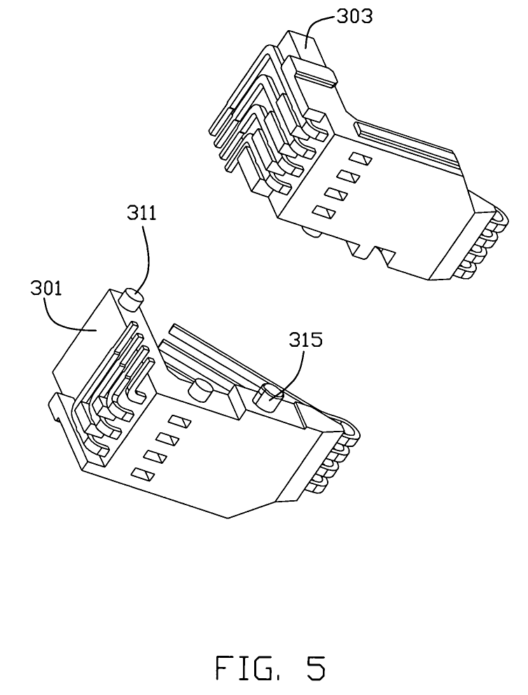

In FIGS. 4 to 7, the upper left and upper right conductor-holding halves 301 and 303 are provided with inter-engaging elements. The lower left and lower right conductor-holding halves are also formed with inter-engaging elements. In this embodiment of FIG. 5, the inter-engaging elements include retaining tabs 311 or 313 extending from one interior side edge of the conductor-holding halves. The conductor-holding halves 301, 303, 401 and 403 are mounted onto the transverse edge section 23 of the main substrate 20 by the inter-engaging elements extending through the corresponding apertures 230 of the main substrate 20. Additionally, inter-engaging element in the form of a post 315, preferably with crushing rib, for example on half 301 and a receiving hole 317 for example on half 303 may be provided to interengage the two upper or lower halves.

Referring to FIGS. 1, 7 and 9, in assembly, the upper left and upper right conductor-holding halves 301 and 303, the lower left and lower right conductor-holding halves 401 and 403, laterally and longitudinally aligned with each other, are detachably mounted upon the opposite front and rear faces of the transverse edge section 23 of the main substrate 20 by the interengaging elements through the apertures 230 of the main substrate 20. The conductors 321, 323, 421 and 423 of the four conductor-holding halves are to be solder tail connection or surface mount connection to the at least one electrically conductive pathway of the main substrate 20, thereby forming an electrical connection between the upper and lower ports, and the main substrate 20. The subassembly of the conductor-holding member and the main substrate 20 is then mounted within the bottom card-edge connector 50 by the lengthwise edge section 21 of the main substrate 20 insertable into the board-receiving channel formed along a lengthwise direction of the card-edge connector 50, thereby forming an electrical connection between the main substrate 20 and the bottom card-edge connector 50. The subassembly of the conductor-holding member, the main substrate 20 and the bottom card-edge connector 50 is then at least partly mounted within the connector housing 10 for completing the upper and lower ports.

As stated above, the connector assembly of this embodiment is configured to have the upper conductor-holding member, comprised of the upper left and upper right conductor-holding halves 301 and 303, for the upper connector, and the lower conductor-holding member, comprised of the lower left and lower right conductor-holding halves 401 and 403, for the lower connector, thereby resulting in dual port connectors. This arrangement of the upper and lower ports shares a common main substrate 20, and is optimal from space usage due to having full advantage of opposed face areas defined by the main substrate 20. It should be noted that the above configuration may be not only employed in a single connector, which is formed by left and right conductor-holding halves, and but also in a multi-port connector assembly, which includes a plurality of side-by-side disposed connector sub-assemblies each including the dual port connectors as described above.

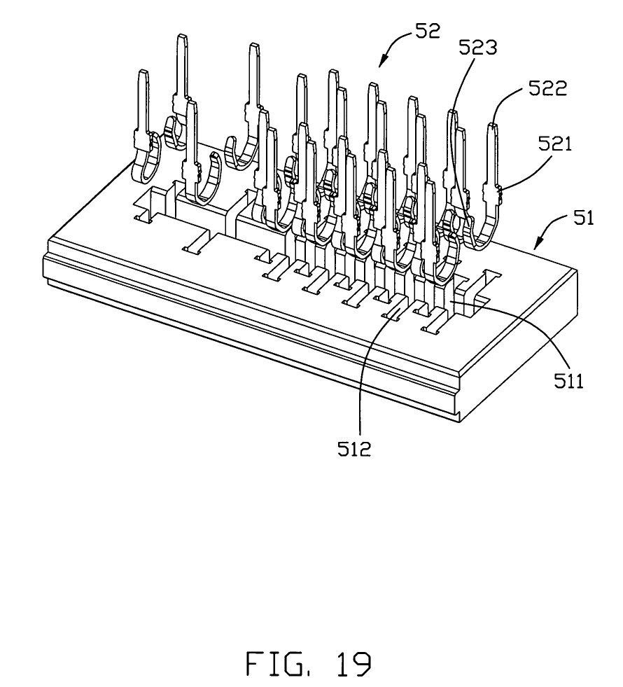

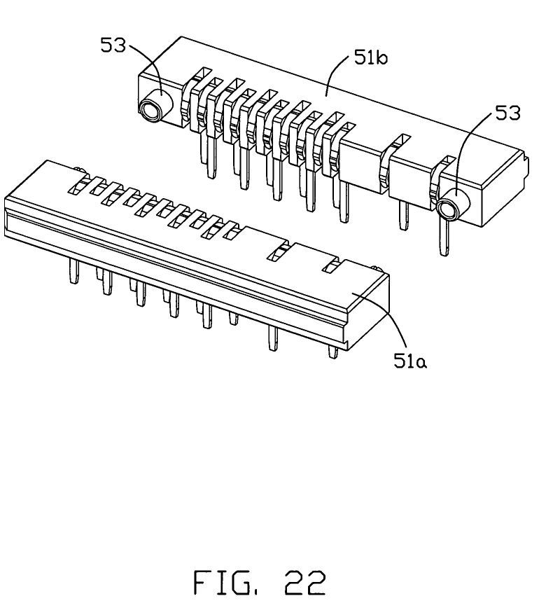

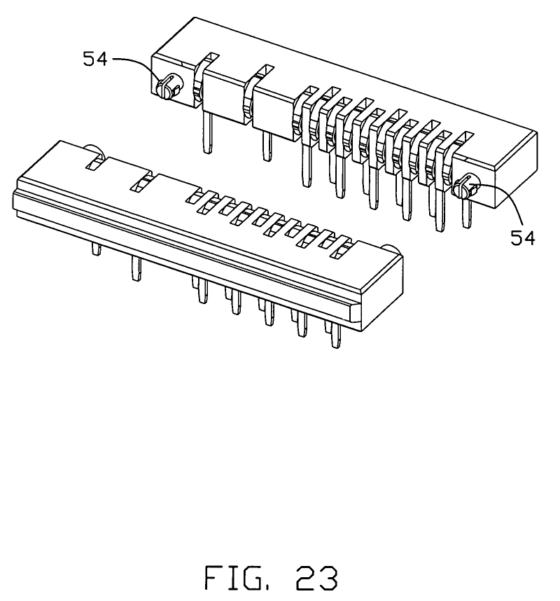

FIGS. 19-23 illustrate the bottom card-edge connector with different embodiments. Particularly referring to FIG. 19, the bottom card-edge connector 50 of this preferred embodiment has a rectangular, insulative housing 51 defining a slot 511, a plurality of channels 512 communicating with the slot 511, and a plurality of footer contacts 52 for receiving in the corresponding channels 512. Each footer contact 52 forms a substantially C-shape contact portion 521, a terminate pin 523, and a retaining portion 522 connecting the contact portion 521 and the terminate pin 523. The retaining portion 522 has barbs (not labeled) along opposite edges thereof. In this embodiment, the insulative housing 51 is formed as a one-piece member.

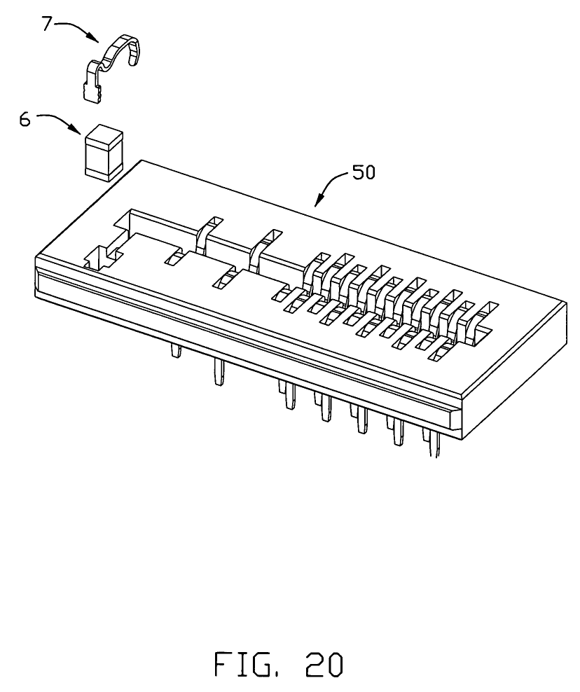

The embodiment shown in FIG. 20 is similar to that of FIG. 19, while, a signal conditioning element 6, such as a capacitor, and a grounding contact 7 are employed to improve the signal transmission quality.

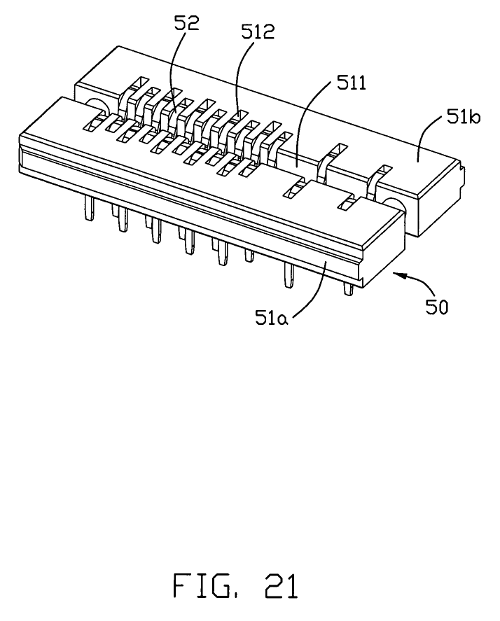

FIGS. 21-23 illustrate another embodiment of the bottom card-edge connector 50, which is assembled by a pair of half members 51a and 51b. Each half has a plurality of footer contacts 52 received in corresponding channels 512. When the two halves 51a, 51b are jointed together, the slot 511 is defined therebetween. A pair of locating posts 53 and a pair of locking posts 54 are respectively formed on the two half members 51a, 51b, which are lockable with each other to thereby secure the bottom card-edge connector 50 on the main substrate 20. Understandably, the main substrate 20 can provide a pair of through holes for receiving the inter-locked posts 53 and 54.

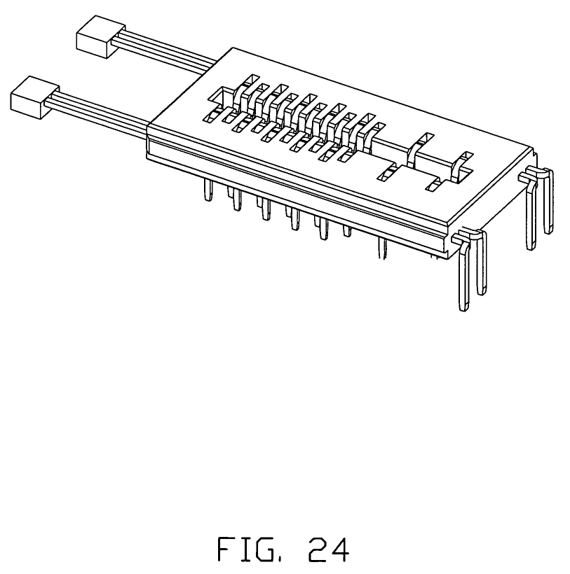

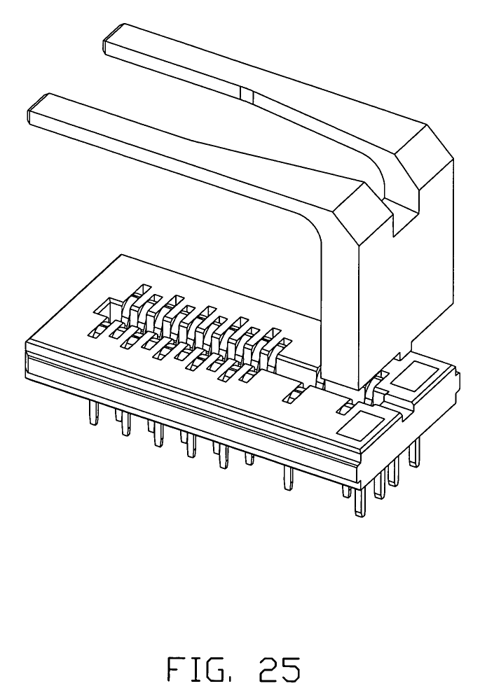

It can be easily seen that different bottom card-edge connector, as shown in FIGS. 24 and 25, will be used according to different outside environments or requirements. Particularly, referring to FIG. 24, a pair of LED are insert-molded in the housing of the bottom card-edge connector 50. While, under certain condition, as shown in 25, a one-piece light pipe and an LED can co-work with each other. The indicating devices are optional.

What is claimed is:

1. An electrical connector assembly comprising:
a plurality of first conductors disposed in a first housing, each of said first conductors comprising a contact section for electrically connecting to terminals of a mated complementary connector, an opposite contact section and an intermediate section connecting said two contact sections;
a plurality of second conductors disposed in a second housing, each of said second conductors comprising a contact portion, a tail portion and a retaining portion connecting said contact portion and said tail portion, said second housing defining a slot with said contact portions exposed thereto; and
a substrate extending between said first and said second housings and removably received in said slot of said second housing, the substrate having a plurality of electrical circuits electrically interconnecting said first and said second conductors.

2. The electrical connector assembly as claimed in claim 1, wherein said first housing defines a slot aligned with the slot of said second housing.

3. The electrical connector assembly as claimed in claim 2, wherein said substrate is partially received in said slot of said first housing.

4. The electrical connector assembly as claimed in claim 1, wherein said slot of said second housing is located in a middle position with respect to said first housing.

5. The electrical connector assembly as claimed in claim 4, wherein each electrical circuit of said substrate has a first conductive end electrically connecting to said first conductor and a second conductive end electrically connecting to said second conductor.

6. The electrical connector assembly as claimed in claim 5, wherein said first conductive ends are arranged along a first direction, and said second conductive ends are arranged along a second direction perpendicularly to said first direction.

7. The electrical connector assembly as claimed in claim 6, wherein each contact portion of said second conductor have a substantially C-shape contact end.

8. The electrical connector assembly as claimed in claim 7, further comprising a plurality of electrical components electrically connecting to said circuits on said substrate.

9. The electrical connector assembly as claimed in claim 1, further comprising a third housing cooperating with said second housing to thereby defining the slot for insertion of said substrate.

10. The electrical connector assembly as claimed in claim 9, wherein said second housing and said third housing defining lockable devices to thereby securely interconnecting said two housings.

11. The electrical connector assembly as claimed in claim 1, further comprising an indicating device including an LED inserted in said second housing and a light pipe assembled thereon.

12. The electrical connector assembly as claimed in claim 1, further comprising a pair of LEDs insert-molded in said second housing.

13. The electrical connector assembly as claimed in claim 1, further comprising a conditional element mounted in said second housing.

14. An electrical modular jack connector comprising:
a first terminal module having a first insulative housing retaining a set of first contacts thereon, each of said first contacts defining a front first contact section and a front first tail section;
a second terminal module having a second insulative housing retaining a set of second contacts thereon, each of said second contacts defining a front second contact section and a front second tail section;
said first terminal module and said second terminal module being side by side intimately assembled to each other in a transverse direction under a condition that the first contact sections and the second contact sections are evenly arranged along a transverse direction with a constant first pitch thereof not only among said first contacts and among said second contact but also between the neighboring first contact section and second contact section, so as to be regarded as a unitary form for coupling to a same complementary plug connector while a distance between the neighboring first tail section and second tail section is larger than said pitch; wherein
a printed circuit board extends perpendicular to said transverse direction and defines a front edge which is sandwiched between a first rear portion of the first terminal module and a second rear portion of the second terminal module in said transverse direction under a condition that the first tail sections approach one surface of said printed circuit board and the second tail sections approach the other surface of said printed circuit board.

15. The electrical modular connector as claimed in claim 14, wherein said first terminal module and said second terminal module are essentially symmetrically arranged on two sides of the printed circuit board.

16. The electrical modular connector as claimed in claim 14, wherein said first tail sections and said second tail sections are assembled to the printed circuit board in either a through hole arrangement or a surface mounting arrangement.

17. The electrical modular connector assembly as claimed in claim 14, wherein said printed circuit board is connected to a main printed circuit board via a card edge connector receiving a bottom edge of the printed circuit board under a condition that a width of said card edge connector is essentially equal to a sum of a first width of the first terminal module and a second width of the second terminal module.

18. An electrical modular jack connector comprising:
a terminal module having an insulative housing equipped with a plurality of contacts categorized with first and second groups in a side-by-side manner, each of said contacts defining a contact section and a tail section, said contact sections of all said contacts being arranged evenly along a transverse direction with an equal pitch thereof for coupling to a same complementary connector,
a printed circuit board extending in a plane perpendicular to said transverse direction and defining opposite first and second surfaces, and
the tail sections of the contacts of the first group being commonly arranged around the first surface and the tail sections of the contacts of the second group being commonly arranged around the second surface and all said tail sections further mechanically and electrically engaged with the printed circuit board.

19. The electrical connector as claimed in claim 18, wherein said printed circuit board is essentially aligned with a center line of said terminal module.
